(19) United States
(12) Patent Application Publication
(10) Pub. No.: US 2010/0220702 A1
(43) Pub. Date: Sep. 2, 2010

(54) LOW POWER CONTROL FOR WIRELESS LAN COMMUNICATION

(75) Inventors: Satoh Hiroyuki, Tokyo (JP); Shoji Kobayashi, Tokyo (JP)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/712,410

(22) Filed: Feb. 25, 2010

Related U.S. Application Data
(60) Provisional application No. 61/156,567, filed on Mar. 2, 2009.

(51) Int. Cl. H04W 4/00

(52) U.S. Cl. 370/338

(57) ABSTRACT

A wireless networking device includes a transceiver that transmits and receives communications over a wireless local area network (WLAN), and a processor cooperatively operable with the transceiver. The processor transmits over the transceiver one WLAN frame of a file transfer to a receiving networking device and then transitioning from transmit power level down to a state of receive power level while waiting for an “ACK” signal to the transmitting. The processor also receives over the transceiver the “ACK” signal from the receiving networking device, and the “ACK” signal triggers going into a doze state of a low power level for a predetermined period of time. The predetermined period of time expires and triggers transitioning the processor to a state of receive power level for an inter-frame space while waiting to transmit a next WLAN frame. The low power receive power level is lower than the receive power level.

### CROSS-REFERENCE TO RELATED APPLICATIONS

This application claims the benefit of the following Provisional application: 61/156,567 filed Mar. 2, 2009, which is expressly incorporated herein by reference.

### TECHNICAL FIELD

The technical field relates in general to wireless networking devices, and more specifically to transmitting and receiving files in a wireless local area network (WLAN).

### BACKGROUND

Recently, many consumer products installed with a wireless LAN interface have been coming out in the consumer marketplace. A Digital Still Camera (or DSC) is a representative example of such devices. The DSC has a capability to be able to communicate by not only a wired interface but also a wireless interface, such as IEEE802.11a/b/g.

As a simple example, a usage is that a high resolution picture captured by the DSC is transferred to a printer by a wireless LAN.

As another usage, the DSC is in communication with an access point at a hot-spot. Through the access point, the user can access a web site on the Internet and an FTP (file transfer protocol) site to upload and transfer the DSC's pictures.

A wireless interface can provide ease-of-use to the end user. It is a fact that the wireless interface is a contribution that helps realize greater portability of the DSC then ever before.

Intrinsically, it is desirable that a product in which portability matters can work with low power during as long a time as possible to maintain the battery life.

Furthermore, in the case of the DSC, it is desirable to transmit the pictures with low power. However, adding the wireless interface into conventional digital portable products increases the power consumption, thereby shortening the battery life.

Accordingly, there is a need for a power reduction method for portable products with a wireless device so as to expand battery life and to achieve low power consumption.

### SUMMARY

Accordingly, one or more embodiments provide a wireless networking device that includes a transceiver operable to transmit and receive communications over at least a portion of a wireless local area network (WLAN); and a processor cooperatively operable with the transceiver. The processor is configured to facilitate transmitting over the transceiver one WLAN frame of a file transfer to a receiving networking device and then transitioning from transmit power level down to a state of receive power level while waiting for an “ACK” signal to the transmitting. The processor is also configured for receiving over the transceiver the “ACK” signal from the receiving networking device, and the “ACK” signal triggers going into a doze state of a low power level for a predetermined period of time. The processor is also configured so that the predetermined period of time expires and triggers transitioning to a state of receive power level for an inter-frame space while waiting to transmit a next WLAN frame, the low power receive power level being lower than the receive power level.

Another embodiment provides a wireless networking device that includes a transceiver operable to transmit and receive communications over at least a portion of a wireless local area network (WLAN); and a processor cooperatively operable with the transceiver. The processor is configured to facilitate transmitting over the transceiver one transmission control protocol (TCP) segment of a file transfer to a receiving networking device and then transitioning down to a state of receive power level while waiting for a MAC “ACK” response to the transmitting. The processor is also configured to facilitate receiving over the transceiver the MAC “ACK” response from the receiving networking device, and the MAC “ACK” response triggers going into a doze state of a low power level for a predetermined period of time. Also, the processor is configured so that the predetermined period of time expires and triggers transitioning to a state of receive power level while waiting to receive a TCP “ACK” response to the TCP segment, the low power receive power level being lower than the receive power level.

Yet another embodiment provides a method of communicating in a wireless local area network (WLAN). The method can include, at a wireless networking device, transmitting one WLAN frame of a file transfer to a receiving networking device and then transitioning from a transmit power level down to a state of receive power level while waiting for an “ACK” signal to the transmitting. The method also can include, at the wireless networking device, receiving the “ACK” signal from the receiving networking device, and the “ACK” signal triggers going into a doze state of a low power level for a predetermined period of time. Also, the method can include, at the wireless networking device, the predetermined period of time expires and triggers transitioning to a state of receive power level for an inter-frame space while waiting to transmit a next WLAN frame, the low power receive power level being lower than the receive power level.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating portions of a wireless networking device;

FIG. 2A-2B are a power level/timing diagram illustrating an example of frame-transmission scenarios;

FIG. 3A-3B are a power level/timing diagram illustrating an example of conventional power save mode frame-transmission scenarios;

FIG. 4A-4B are a power level/timing diagram illustrating an example of TCP communication scenarios without CTS (clear-to-send) protection mechanism;

FIG. 5A-5B are a power level/timing diagram illustrating an example of TCP communication scenarios with CTS protection mechanism;

FIG. 6A-6B is a power level/timing diagram illustrating an example of conventional power save mode TCP communication scenarios;

FIG. 7 illustrates a frame structure relationship from “User data” level to IEEE892.11g MAC/PHY frame level;

FIG. 8 illustrates a frame structure of MAC (media access control) ACK/PHY frames;

FIG. 9 illustrates test results;

FIG. 10 is a flow chart illustrating a procedure to communicate in WLAN at WLAN frame level; and

FIG. 11 is a flow chart illustrating a procedure to communicate in WLAN at TCP segment level.

### DETAILED DESCRIPTION

In overview, the present disclosure concerns wireless networking devices or units, often referred to as wireless units or wireless devices, such as a digital image capturing device, digital still camera (DSC), home display, printer, photo printer or the like utilizing wireless communication, such as the wireless LAN (WLAN) standard defined by The Institute of Electrical and Electronics Engineers, Inc. (IEEE). Such communication systems may further provide for wirelessly transmitting and receiving files between the wireless devices within the WLAN, where such files include picture, video, and/or data. More particularly, various inventive concepts and principles are embodied in systems, wireless networking devices, and methods therein for reducing power consumption associated with a file transfer from a wireless networking device.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As further discussed herein below, various inventive principles and combinations thereof are advantageously employed to reduce use of power by wireless networking devices, and more particularly when wirelessly transmitting and/or receiving picture, video and data between the digital image capturing devices and home display, printer and photo printer and so on utilizing wireless communication, such as the WLAN standard defined by IEEE. By entering a doze state after the ACK which signals successful transmission of the frame, and leaving the doze state before the next frame in the multi-frame file is sent, lower power can be used. In addition, and/or alternatively, a doze state can be entered after the MAC ACK and left before the TCP ACK that are exchanged to successfully complete transmission of a TCP segment, in a multi-segment transmission, also resulting in lower power usage. By using the doze state while transmitting the plural frames and/or plural TCP segments in the single file, power usage is decreased.

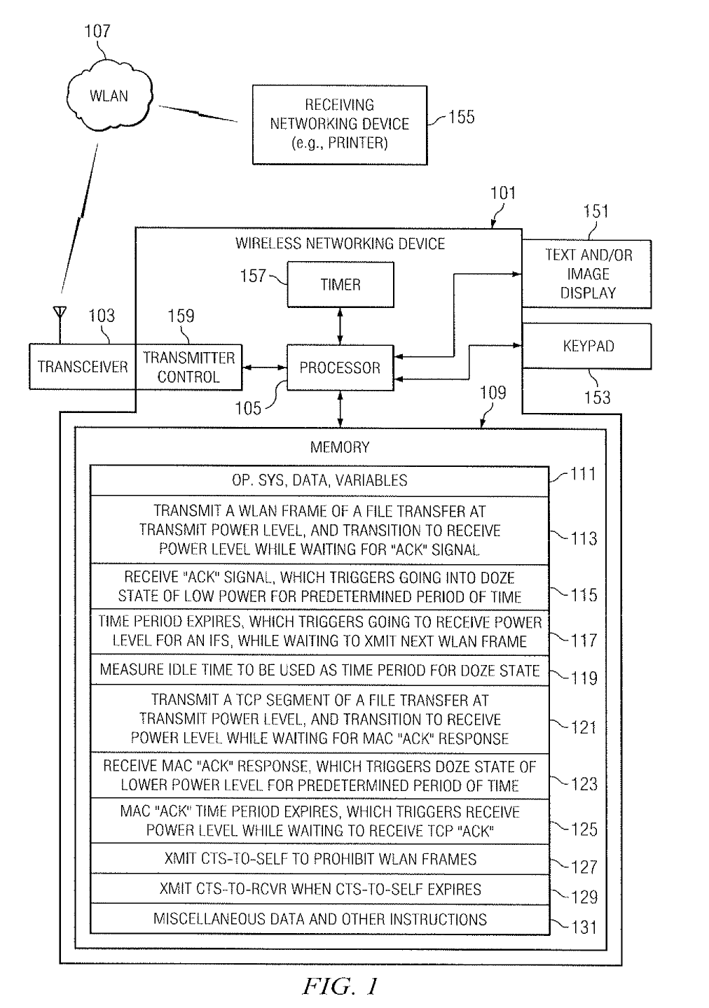

Referring now to FIG. 1, is a block diagram illustrating portions of a wireless networking device will be discussed and described. The wireless networking device 101 may include a transceiver 103 for communication over a wireless local area network 107 to a receiving networking device 155 in the WLAN, a processor 1105, a memory 109, a text and/or image display 151, a user input device such as a keypad 153, a timer 157, and a transmit control 159. The processor 105 can be connected to the transceiver 103, transmit control 159, timer 157, display 151, memory 109, and keypad 153 using components which are well understood and therefore will not be discussed herein. The receiving networking device 155 can be equipped with wireless receiving capability that is complementary to the wireless capability of the wireless networking device 101, and which can communicate wirelessly in accordance with the WLAN standard defined by IEEE, e.g., the IEEE 802.11x standards, variations, and evolutions thereof.

The user may invoke functions accessible through the user input device 153. The user input device 153 may comprise one or more of various known input devices, such as a keypad, a computer mouse, a touchpad, a touch screen, a trackball, and/or a keyboard. Responsive to signaling from the user input device 153, in accordance with instructions stored in memory 109, or automatically upon receipt of certain information via the transceiver 103, the processor 105 may direct stored information or received information, such as a file or picture file to be transmitted by the transceiver 103 via the transmit control 159. The text and/or image display 151 may present information to the user by way of a conventional liquid crystal display (LCD) or other visual display, and/or by way of a conventional audible device (not illustrated) for playing out audible messages.

The processor 105 may comprise one or more microprocessors and/or one or more digital signal processors. The processor 105 can be equipped to put the device so it is running in different power management modes: in the “doze state” of low power, defined in the IEEE 802.11x standards, e.g., “11.2.1.1 STA Power Management modes,” IEEE 802.11 (1999) standard, in which the device is not able to transmit or receive; in a “transmit power level” the device is able to transmit and receive; in a “receive power level” the device is able to receive but not transmit. The memory 109 may be coupled to the processor 105 and may comprise a read-only memory (ROM), a random-access memory (RAM), a programmable ROM (PROM), and/or an electrically erasable read-only memory (EEPROM). The memory 109 may include multiple memory locations for storing, among other things, an operating system, data and variables 111 for programs executed by the processor 105; computer programs for causing the processor to operate in connection with various functions such as transmit 113 a WLAN frame of a file transfer at transmit power level and transition to receive power level while waiting for the “ACK” signal; receive 115 an “ACK” signal which triggers going into a doze state of low power for a predetermined period of time; the time period expires 117 which triggers going to receive power level for an inter frame space (IFS) while waiting to transmit the next WLAN frame; measure 119 the idle time to be used as the time period for the doze state; transmit 121 a TCP segment of a file transfer at the transmit power level and transition to the receive power level while waiting for a MAC (media access control) “ACK” response; receive 123 the MAC “ACK” response which triggers the doze state of low power level for a predetermined period of time; the MAC “ACK” time period expires 125 which triggers the receive power level while waiting to receive a TCP “ACK”; transmit 127 clear-to-send (CTS)-to-self to prohibit receipt of WLAN frames; transmit 129 CTS-to receiving networking device when CTS-to-self expires, and/or other processing; and a database 131 for other information used by the processor 105. The computer programs may be stored, for example, in ROM or PROM and may direct the processor 105 in controlling the operation of the wireless networking device 101. Each of these functions of the computer programs is introduced by way of example below; further discussion may be provided subsequently.

The processor 105 may be programmed to transmit 113 a WLAN frame of a file at the transmit power level and transition to receive power level while waiting for the “ACK” signal. Known techniques can be used to transmit the WLAN frame of the file which is being transmitted from the wireless networking device 101, for example to the receiving networking device 155. Triggered by the end of the WLAN frame, the processor powers down to receive power level, and waits to receive the “ACK” response from the receiving networking device 155. The receiving networking device 155 can be equipped with a WLAN transceiver and a coordinating protocol and will send an “ACK” to the wireless networking device 101 if the WLAN frame is successfully received.

The processor 105 may be programmed to receive 115 an “ACK” signal which triggers going into a doze state of low power for a predetermined period of time. The reception of the expected “ACK” signal by the processor 105 triggers the processor to go to the doze state of low power for a predetermined period of time between frames in a plural-frame transmission. The processor 105 determines the period of time for the doze state before entering the doze state, and at the end of the predetermined period of time the processor powers up to at least a receive power level.

The processor 105 may be programmed so that, when the time period expires 117 it triggers going to receive power level for an inter frame space (IFS) while waiting to transmit the next WLAN frame. Hence, the predetermined period of time for the doze state can be the time between frames less the inter frame space, to allow some leeway.

The processor 105 may be programmed to measure 119 the idle time to be used as the time period for the doze state. The idle time can be learned before sending the current frame, for example, during the initial handshaking between the wireless networking device 101 and the receiving networking device 155 by timing the length of time from the last transmitted data of a frame until the ACK signal is received.

The WLAN functionality of transmitting 113 a WLAN frame, receiving 115 an ACK signal and going into the doze state, and triggering 117 receive power level can be repeated for plural frames in a file transfer. Said WLAN functionality can be incorporated into a WLAN frame processing layer sometimes referred to as the physical layer or Layer 1 processing.

Also, the processor 105 may be programmed to transmit 121 a TCP segment of a file transfer at the transmit power level and transition to the receive power level while waiting for a MAC “ACK” response. Known techniques can be used to transmit the segment of the file which is being transmitted from the wireless networking device 101, for example to the receiving networking device 155. Triggered by the end of the segment, the processor powers down to receive power level, and waits to receive the MAC “ACK” response from the receiving networking device 155. The receiving networking device 155 can be equipped with a WLAN transceiver and a coordinating protocol and will send a MAC “ACK” to the wireless networking device 101 if the segment is successfully received.

The processor 105 may be programmed to receive 123 the MAC “ACK” response which triggers the doze state of low power level for a predetermined period of time. The reception of the expected MAC “ACK” signal by the processor 105 triggers the processor to go to the doze state of low power for a predetermined period of time between segments in a plural-segment transmission. The processor 105 determines the period of time for the doze state before entering the doze state.

The processor 105 may be programmed so that, when the MAC “ACK” time period expires 125 it triggers the receive power level while waiting to receive a TCP “ACK”. At the end of the predetermined period of time the processor 105 powers up to at least a receive power level. The predetermined period of time for the doze state can be equivalent to a time measured between the MAC ACK following a segment transmission and the TCP ACK, less a time lag to allow some leeway. The processor will expect to receive a TCP ACK, and then send a MAC ACK in accordance with 802.11 standards, thereby completing the successful transmission of the TCP segment.

The processor 105 may be programmed to transmit 127 CTS-to-self to prohibit receipt of WLAN frames, which prohibits other devices from transmitting to the wireless networking device according to 802.11 standards. The CTS-to-self can be transmitted prior to transmitting 121 the TCP segment of the file. This can prevent missed segments whilst the processor 105 is in the doze state after sending the TCP segment. In accordance with the 802.11 standards, the CTS-to-self is understood to eventually time out after a known period of time.

The processor 105 may be programmed to transmit 129 CTS-to receiving networking device when CTS-to-self expires or when the predetermined period of time for the doze state expires. The CTS transmitted from the wireless networking device 101 to the wireless receiving device 155 is understood, according to 802.11 standards, to indicate that the wireless receiving device 155 is clear-to-send to the wireless networking device 101. The processor 105 will expect to receive a TCP ACK, and then send a MAC ACK in accordance with 802.11 standards, thus completing the successful transmission of the TCP segment.

The TCP segment functionality of transmitting 121 a TCP segment, receiving 123 a MAC ACK response and going into the doze state, triggering 125 receive power level, CTS-to-self, and CTS-to-RCVR functionality can be repeated for plural TCP segments in a file transfer. Said TCP segment functionality can be incorporated into a TCP processing layer sometimes referred to as the Layer 4 processing.

It should be understood that various logical groupings of functions are described herein. Different realizations may omit one or more of these logical groupings. Likewise, in various realizations, functions may be grouped differently, combined, or augmented. Furthermore, variations can omit functions. For example, a variation of the device 101 can omit the CTS-to-receiving device 129 function, or can omit the CTS-to-self 127 function. Also, a variation of the device 101 can omit the TCP-segment specific processing that includes the doze state of low power 121, 123, 125 as further explained herein. A further variation of device 101 omits the WLAN-frame specific processing that includes the doze state of low power 113, 115, 117, 119 as further explained herein.

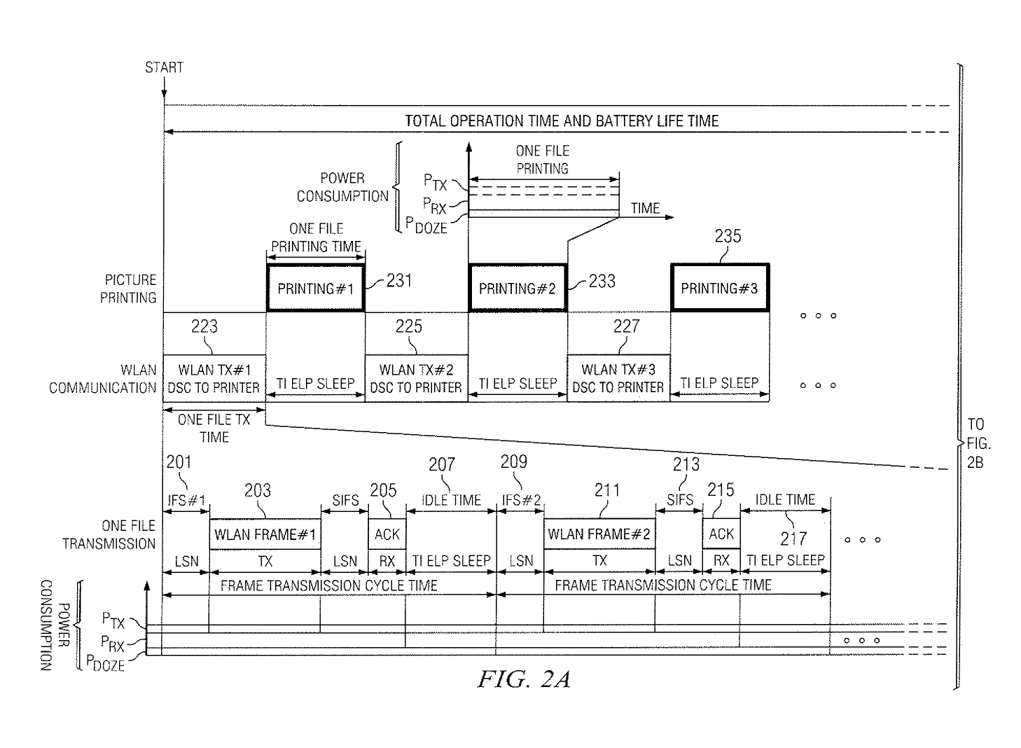

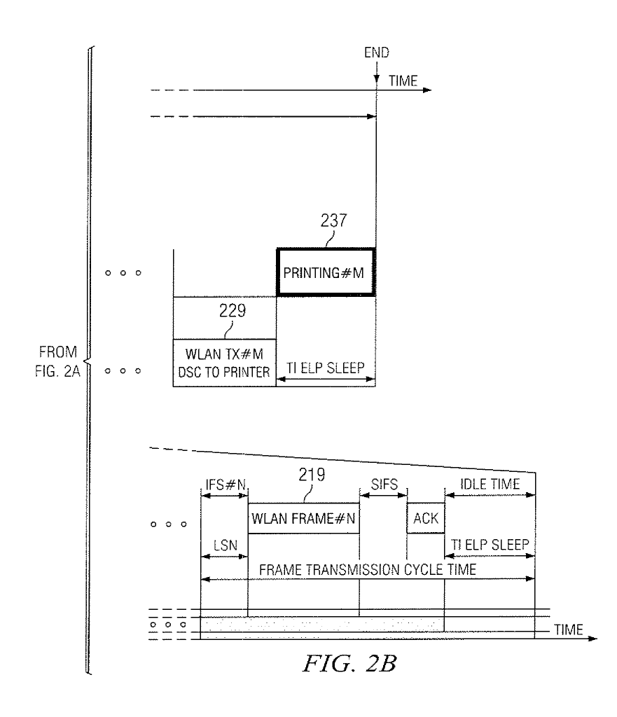

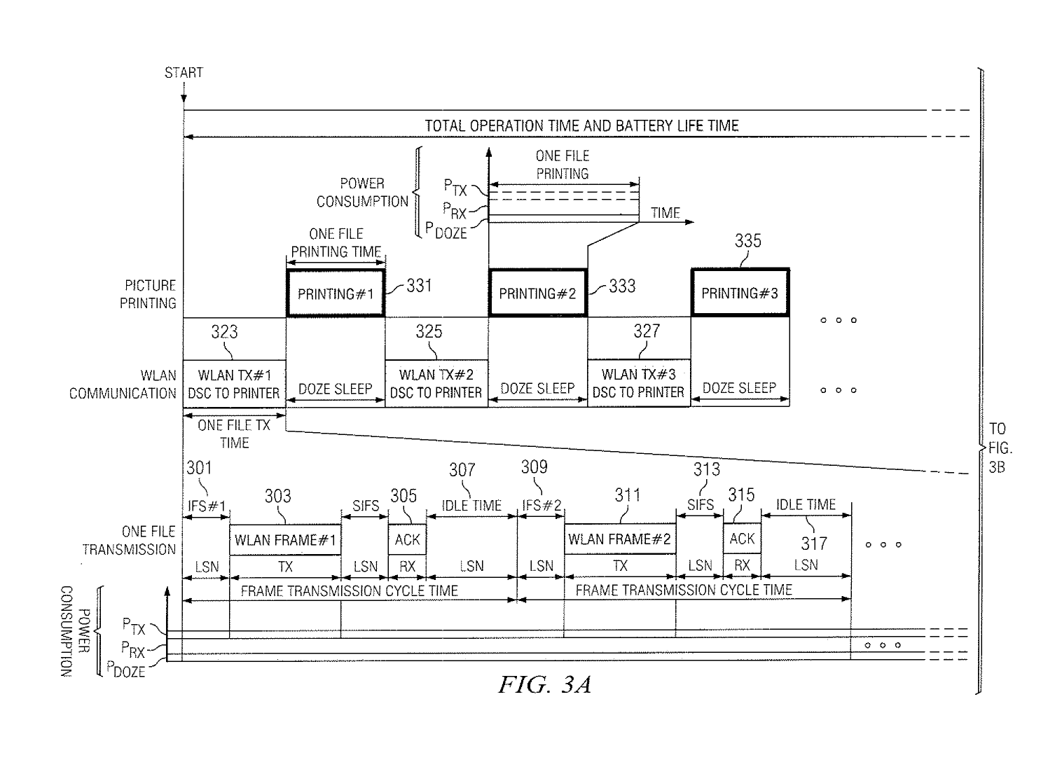

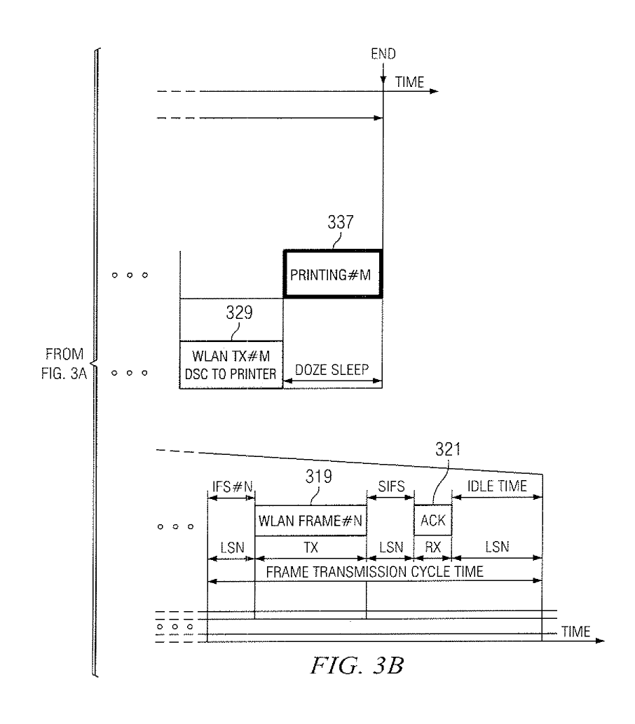

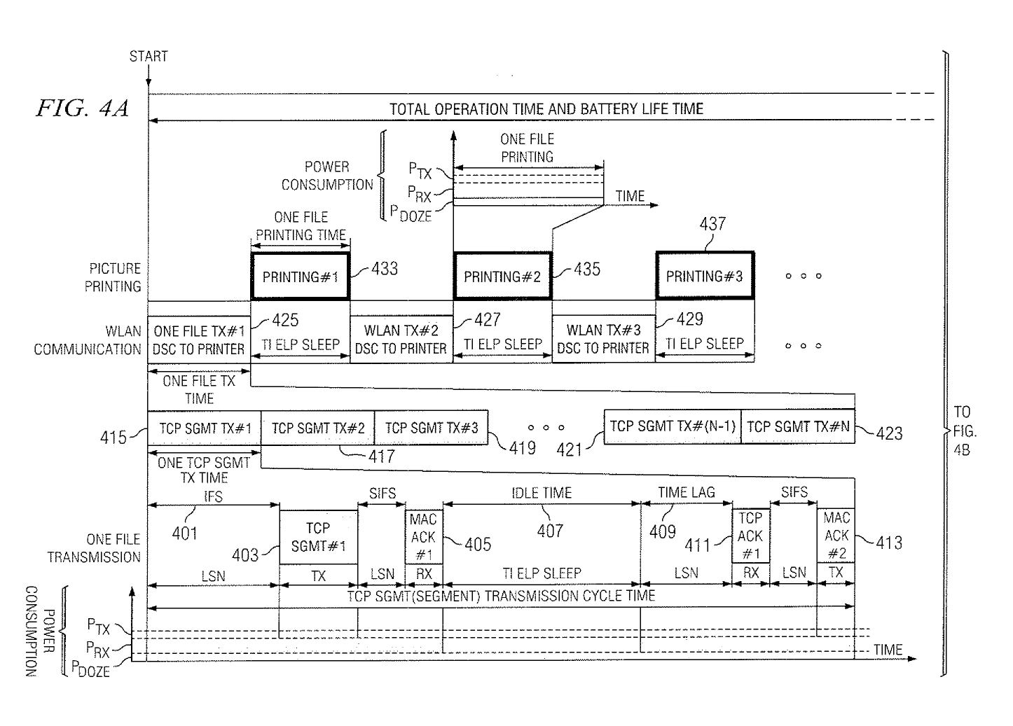

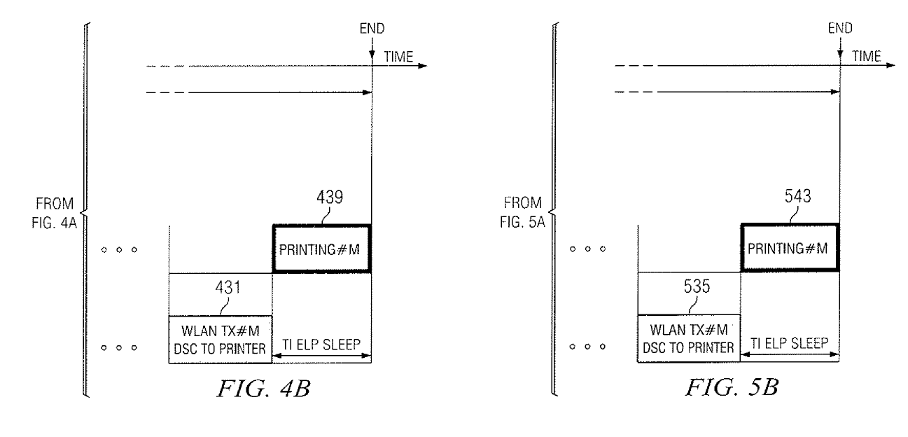

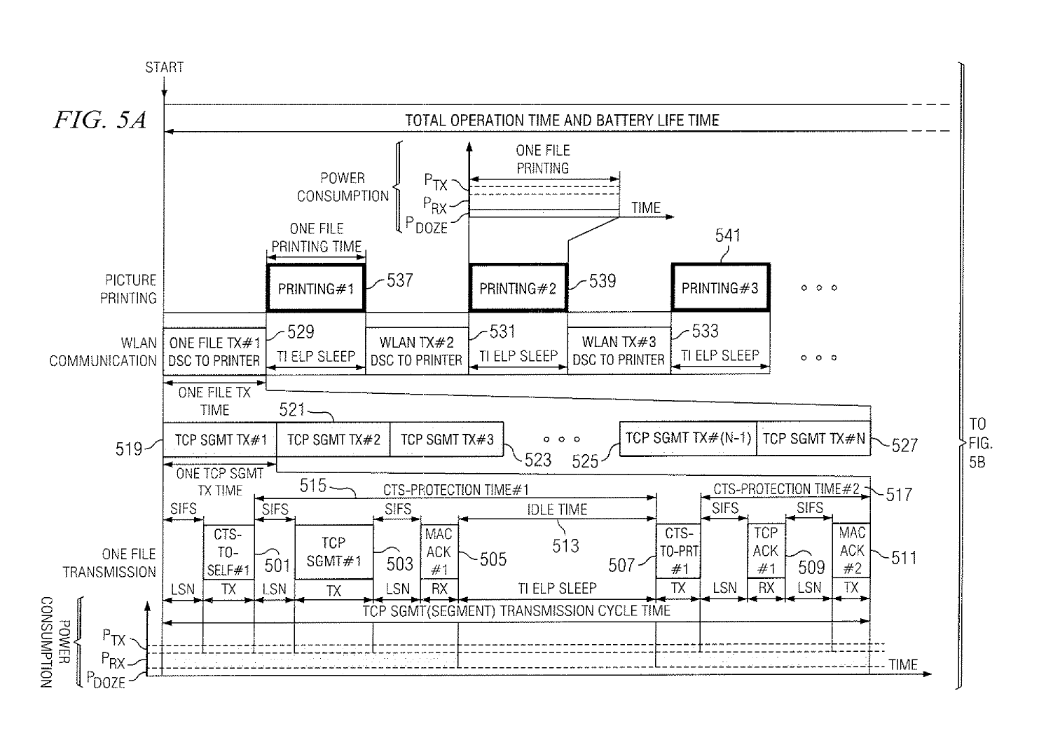

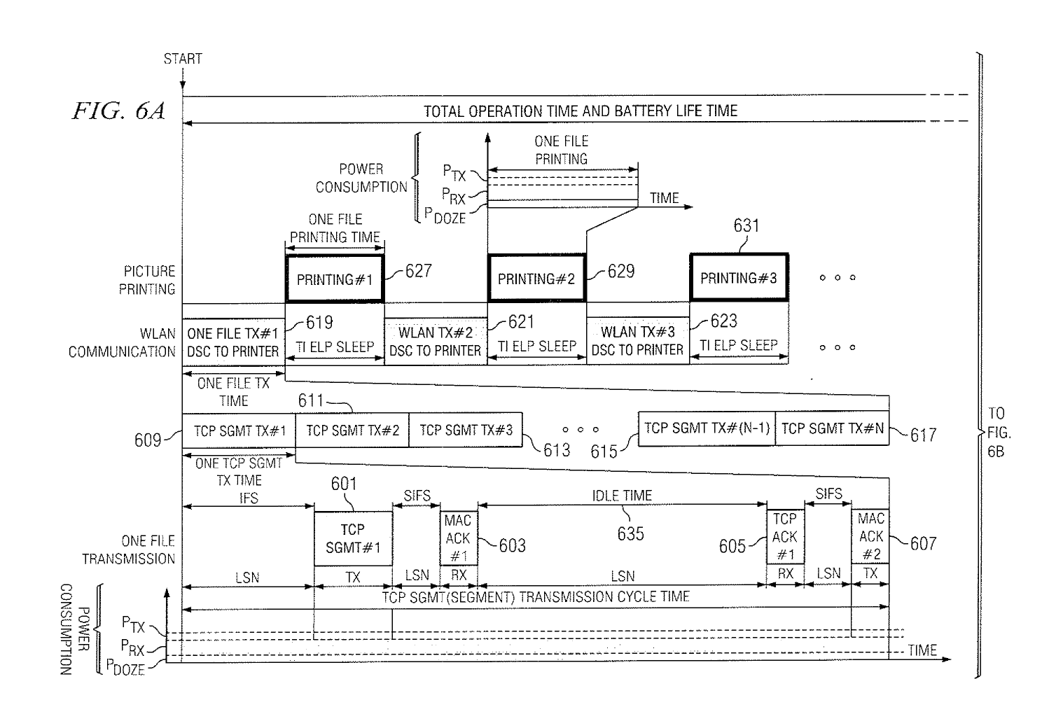

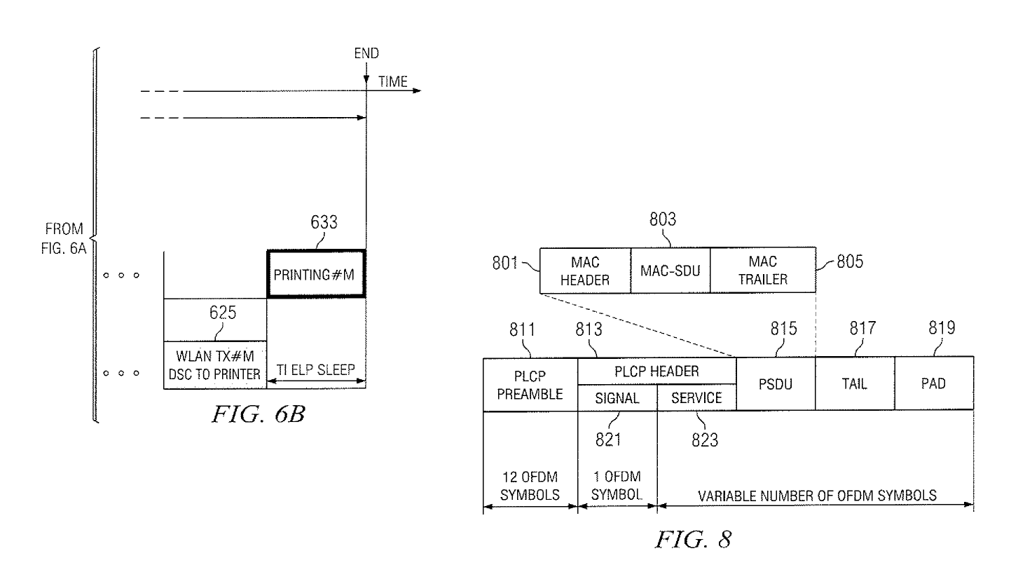

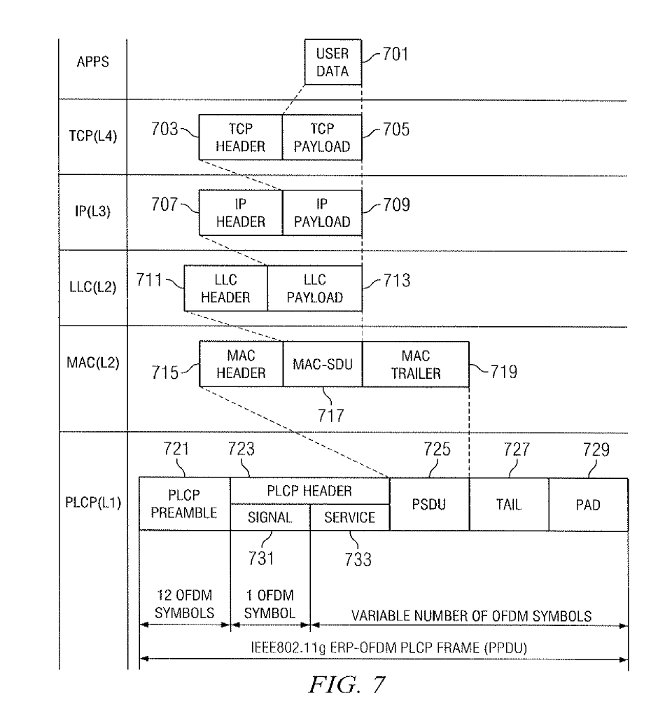

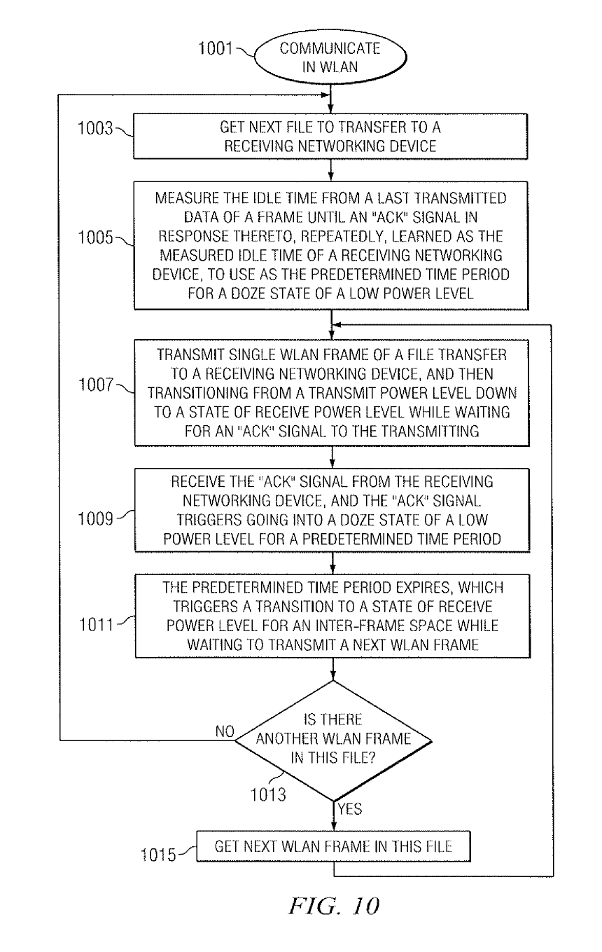

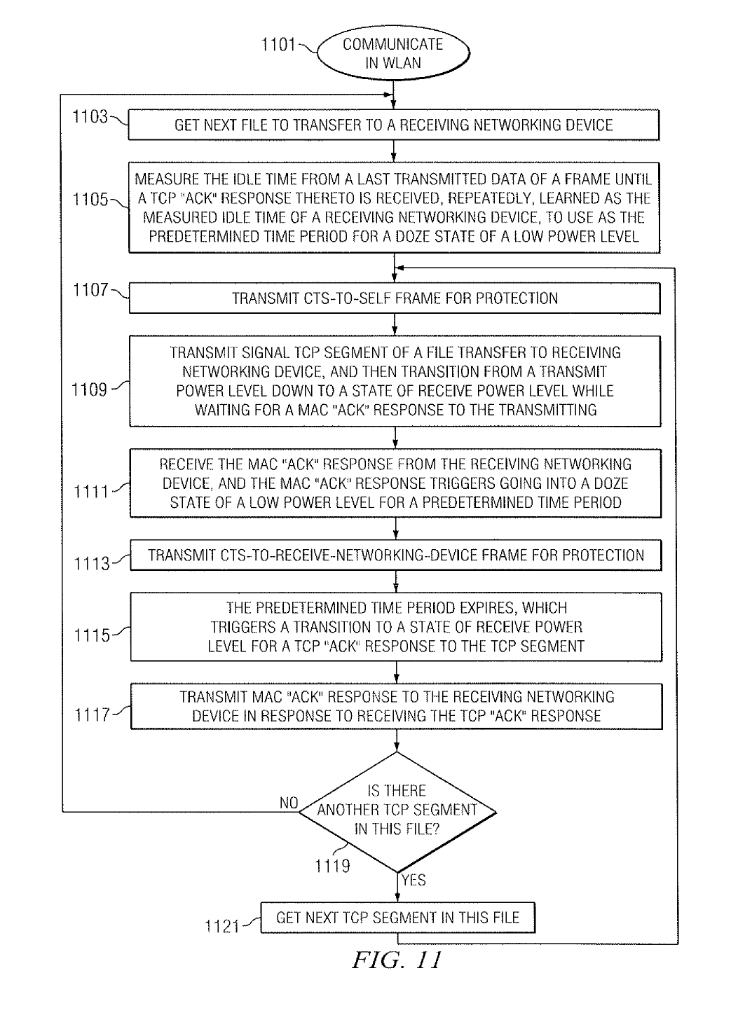

FIG. 2A-2B, and FIG. 3A-3B illustrate frame transmission scenarios and FIG. 10 illustrates a related procedure; whereas FIG. 4A-4B, FIG. 5A-5B and FIG. 6A-6B illustrate TCP communication scenarios and FIG. 11 illustrates a related procedure. The frame transmission scenarios and TCP communication scenarios discussed herein can be used together at TCP and frame layers of layered processing as illustrated in FIG. 7, and/or may be used separately.

FIG. 2A-2B and FIG. 3A-3B both are power level/timing diagrams illustrating frame transmission scenarios. The illustration of FIG. 2A-2B can be compared to the conventional power save mode of the frame communication scenario illustrated in FIG. 3A-3B.

Referring now to both FIG. 2A-2B and FIG. 3A-3B, a power level/timing diagram illustrating an example of frame-transmission scenarios (FIG. 2A-2B), and a power level/timing diagram illustrating an example of conventional power save mode frame-transmission scenarios 3A-3B) will be discussed and described. A concrete example will now be described with reference to FIG. 2A-2B and FIG. 3A-3B in the situation of the communication between a DSC and a printer of a file to be printed. The printer can have the capability to communicate by WLAN, such as defined by IEEE802.11 (e.g., IEEE802.11a/b/g, and variations and evolutions thereof). In these and other examples herein, the DSC is representative of a wireless networking device, and the printer is representative of a receiving networking device.

Usually, a wireless device with WLAN has a capability to go into a power down mode. A typical power down mode is described in FIG. 3A-3B as the conventional mode. In this conventional mode, the power down mode can be realized in the duration between transmitting a (TX# [N]) and next transmitting (TX# [N+1]). This is addressed as “DOZE SLEEP”. “DOZE SLEEP” is specified as “Doze state” in the “11.2.1.1 STA Power Management modes,” IEEE802.11 (1999). This duration of “DOZE SLEEP” is almost equal to a time when a printer is working after the picture data. It works efficiently because it can save the power consumption when many pictures will be transmitted to printer.

If the power consumption for transmitting each picture is defined as W, total power consumption becomes W times the number of pictures (N)=N×W. Furthermore, during a conventional transmit operation from a DSC to a printer, the DSC using WLAN communication has to operate as a transmitter to send picture data and as a receiver to receive an “ACK” signal from a receiver. The power for transmitting and receiving in each phase addressed at TX# is referred to as P_{Tx} (defined herein as “transmit power level”) and P_{Rx} (defined herein as “receive power level”). The power for transmitting in the doze sleep is referred herein as a “low power level.” “Low power level” is further defined as lower than “receive power level”; “receive power level” is further defined herein as lower then “transmit power level”.

And, power consumption in the conventional mode in each duration W (TX#) is given by P_{TX}+P_{RX}. Both P_{TX} and P_{RX} relate to time (t) and depend on the active time for each. Accordingly, in the conventional mode, total power consumption is W times the number of transmitted pictures.

As illustrated in FIG. 3A-3B, in order to transmit one of the picture files 323, 325, 327, 329 from the DSC to the printer, conventional WLAN communication consists of several frames 303, 311, 319 as packet data. The structure of plural frames used for transmitting one or more packets is known. The DSC is waiting at a receive power level for an inter frame space 301, 309 before sending one frame. According to a conventional communication protocol, once the DSC transmits one frame to the printer, the DSC needs to wait for an acknowledgement response signal (ACK) 305, 315, 321 from the printer while the DSC is in the receive mode. SIPS (short inter frame space) 313 in FIG. 3A-3B means the time the DSC is to wait for the ACK 315 from the printer. After receiving the ACK, the DSC can transmit the next frame to the printer in the transmit mode. However, it takes a little time until the DSC is ready for transmitting the next frame. This time appears in FIG. 3A-3B as IDLE TIME (=LSN) 307, 317. During the DSC's time spent as LSN, P_{RX} (LSN) will be consumed while there is no WLAN communication, thus wasting power.

As usual, the operation between transmitting and receiving the ACK is handled by a known hand-shaking operation. So, a transmitter side (e.g., DSC) needs to wait for the ACK signal from a receiver side (e.g., printer) and enters receive power level P_{RX} (LSN) because the DSC is waiting only for the ACK signal. The receive side (e.g., printer) can print 331, 333, 335 the file that is has received and the transmitter side (e.g., DSC) is at doze power level when the receive side is printing the one file.

As illustrated in FIG. 2A-2B, in order to transmit one of the picture files 223, 225, 227, 229 from the DSC to the printer, the WLAN communication consists of several frames 203, 211, 219 as packet data, according to known packet structure. The DSC waits at a receive power level for an inter frame space 201, 209 before sending one frame. According to a conventional communication protocol, once the DSC transmits one frame to the printer, the DSC needs to wait for an acknowledgement response signal (ACK) 205, 215, from the printer. SIFS (short inter frame space) 213 is also illustrated in FIG. 2A-2B.

In FIG. 2A-2B, by employing a counter in a WLAN circuit (sometimes referred to as a timer) to measure the IDLE TIME (LSN) 207, 217, a transmitter can go forward into the “Doze state” once the ACK signal 205, 215 is received, and during IDLE TIME 207, 217, P_{DOZE}(LSN) will be consumed and a low power condition can be achieved in comparison with the conventional mode.

Regarding the LSN time, in the initial stage for negotiation with each other, the LSN can be measured by working a timer to time from the last transmitted data of a frame 203, 211 until receiving the ACK signal 205, 215. And, to avoid a possibility that a transmitter might miss the ACK signal 205, 215, some safety margin is added to the actually measured time of the LSN. This value for the margin is calculated by repeatedly measuring to learn the value. After measuring the LSN time, it will be set into WLAN circuit. A communication for picture data transfer between DSC and printer will start transmitting picture data by dropping the power level to P_{DOZE}(LSN) and waking up to receive the ACK signal 205, 215 at the receive power level. The receiver, e.g., the printer, prints one file 231, 233, 235, 237 after each is received.

In the example of FIG. 2A-2B, the power consumption is {P_{RX}(LSN)+P_{TX}(LSN) P_{DOZE}(LSN)}×a number of pictures. By entering the DOZE stage while transmitting every frame, a lower power solution can be realized.

FIG. 4A-4B, FIG. 5A-5B and FIG. 6A-6B are power level/timing diagrams illustrating TCP transmission scenarios. The illustration of FIG. 4A-4B and FIG. 5A-5B can be compared to the conventional power save mode of the TCP communication scenario illustrated in FIG. 6A-6B. FIG. 5A-5B illustrates use of CTS protection time, in comparison to FIG. 4A-4B without CTS protection time.

Referring now to FIG. 4A-4B, a power level/timing diagram illustrating an example of TCP communication scenarios without CTS-protection mechanism will be discussed and described. FIG. 4A-4B shows the WLAN communication of tiles 425, 427, 429, 431 from a DSC to a printer. WLAN communication between the DSC and the printer usually uses TCP as the Layer-4 protocol to transmit TCP segments 415, 417, 419, 421, 423. Conventional TCP protocol has a handshake mechanism in order to confirm that the TCP receiver side correctly receives a TCP segment transmitted by a TCP transmitter side. The handshake mechanism is that a TCP receiver side transmits a TCP Acknowledge (ACK) 411 frame back to the TCP transmitter side when the received TCP segment 403 does not have any error, e.g., no checksum error. So, the printer needs to transmit a TCP ACK 411 frame back to the DSC when the printer receives a TCP segment 403 correctly. However, the printer cannot transmit a TCP ACK frame immediately when receiving a TCP segment, because the printer needs to calculate, e.g., the check sum of the received TCP segment which takes some time to calculate due to lower CPU performance of the printer.

As illustrated in FIG. 4A-4B, while the printer prepares to transmit a TCP ACK 411 frame back to the DSC, the DSC can go forward into a “doze state”. The predetermined period of time for the “doze state” time is described as “IDLE TIME” 407 in FIG. 4A-4B. The “IDLE TIME” 407 can be measured through previous experiments by measuring, in one or more previous segments, from the last transmitted data of the MAC ACK 405 until the TCP ACK 411 response in response to the previous segment 403 is received. However, the experimentally measured “IDLE TIME” 407 may be shorter or longer than the actual “IDLE TIME” of the printer. So, the experimental “IDLE TIME” 407 should be reduced in order to safe guard the time. The safe guard time is described as “TIME LAG” 409 in FIG. 4A-4B.

The sequence as described in FIG. 4A-4B is shown below. At first, the DSC waits for an IFS (inter frame space) time 401 and then transmits a TCP segment 403. The printer transmits a MAC ACK 405 frame back to the DSC in SIFS after receiving the TCP segment 403. As soon as the DSC receives the MAC ACK 405 frame, the DSC goes forward into “Doze state” and stays in “Doze state” during the “IDLE TIME” 407. The DSC wakes up when the “IDLE TIME” 407 expires. After the DSC wakes up, the printer transmits a TCP ACK 411 frame within the “TIME LAG” 409. And then, the DSC transmits a MAC ACK 413 frame back to the printer in SIFS time. After that, it will be repeated until the DSC finishes transmitting one file as “ONE FILE TX#n”, where n is 1 through M. The printer then will print the one file 433, 435, 437, 439.

Referring now to FIG. 5A-5B, a power level/timing diagram illustrating an example of TCP communication scenarios with CTS-protection mechanism will be discussed and described. This embodiment proposes to reduce the power consumption by using a clear-to-send (CTS) protection. In FIG. 4A-4B, “IDLE TIME” can be experimentally determined and can account for a “TIME LAG” in order to not make the DSC miss a TCP ACK frame. If the DSC controls the transmitting timing of a TCP ACK frame transmitted by the printer, however, as illustrated in FIG. 5A-5B, then the DSC can stay in the “doze state” during the “IDLE TIME” and the “TIME LAG” can be more minimized. Furthermore, the DSC can further reduce power consumption for the WLAN through controlling the transmitting time of a TCP ACK frame.

As illustrated in FIG. 5A-5B, the CTS-protection mechanism can be used in order to control the transmitting time of a TCP ACK 509 frame transmitted by the printer. The CTS-protection mechanism is specified in “9.10 Protection mechanism”, IEEE802.11 g (2003), variations and evolutions thereof. As is known, when a CTS frame is transmitted, a WLAN station that is the destination of the CTS frame can take a transmission privilege during a “duration” time set in the CTS frame, and other WLAN stations except the WLAN station as the destination of the CTS frame are prohibited from transmitting any WLAN frame during the “duration” time. So, a WLAN station can transmit a CTS frame to itself as specified in IEEE802.11 g (2003). It is called “CTS-to-self” in IEEE802.11 g. In IEEE802.11 g, CTS-to-self protection mechanism can be used in order to inform other WLAN stations which cannot detect ERP-OFDM preamble that an ERP-OFDM frame is transmitted during the “duration” time, and then the other WLAN stations must not transmit any WLAN frame during the “duration time”. The original purpose of “CTS-to-self” as specified in IEEE802.11 g (2003) is that a WLAN station itself transmits a WLAN frame without any disturbance. The purpose of “CTS-to-self” 501 as used herein instead is that any WLAN station including a WLAN transmitter of a CTS frame is prohibited from transmitting any WLAN frame. So “CTS-to-self” 501 is used so that the DSC can stay in the “doze state” without missing any WLAN frame because any WLAN station including the printer does not transmit any WLAN frame due to the CTS-protection mechanism.

The CTS-protection mechanism can be applied to another purpose also. When the DSC moves from the “doze state” to an awake state, the DSC wants to receive a WLAN frame from the printer and then go forward into the “doze state” as immediately as possible in order to reduce the power consumption of the DSC related to the WLAN function as much as possible. However, in general, a WLAN station may transmit a WLAN frame and the printer cannot necessarily transmit a WLAN frame to the DSC immediately after the duration time of the CTS-to-self expires. In order to make the printer transmit a WLAN frame to the DSC immediately after the expiry of the duration time, the DSC transmits a “CTS-to-Printer” 507 before or just after the CTS-to-self duration time expires. The expiration of the duration time of the “CTS-to-self” can be set so as to expire when the CTS-to-Printer should be transmitted. According to IEEE802.11 (1999), the printer transmits a WLAN frame to the DSC immediately after receiving the CTS-to-PRT 507 frame from DSC.

The sequence of FIG. 5A-5B is shown below. At first, the DSC transmits a CTS frame as CTS-to-self 501. The duration time 515 of the CTS-to-self (CTS protection time) consists of a first SIFS time, a transmission time of a TCP segment 503 from the DSC to the printer, a second SIFS time, a transmission time of a MAC ACK 505 frame from the printer to the DSC, and the IDLE TIME 513 as shown in FIG. 5A-5B. According to the 802.11a/b/g specification, any WLAN station except the DSC cannot transmit any WLAN frame until the duration time 515 of CTS-to-self expires. The duration time can have some additional guard time. A DSC can transmit a TCP segment 503 in SIPS time after the CTS frame as the CTS-to-self. And then, the printer can transmit a MAC ACK 505 frame to the DSC. After receiving the MAC ACK 505 frame from the printer, the DSC goes forward into the doze state. In the IDLE time 513, the DSC moves from the doze state to the awake state and then immediately transmits a CTS frame as CTS-to-printer 507 in order to make the printer immediately transmit a TCP ACK frame. After receiving the CTS frame as “CTS-to-Printer” 507, the printer transmits a TCP ACK 509 frame to the DSC. In SIFS time after the TCP ACK 509 frame, the DSC transmits a MAC ACK 511 frame to the printer and then transmits the next TCP segment after a SIFS time, if needed.

The IDLE time 513 can be a little bit longer than the time it takes the printer from receiving a TCP segment to transmitting a TCP ACK frame in response thereto without using CTS-protection in order to reduce power consumption of DSC related to WLAN function as much as possible. This time can be measured by sending a test TCP segment and measuring from the last data of the test TCP segment to the received TCP ACK. The IDLE time 513 is trade-off between reduction of power consumption and throughput. On the other hand, if the IDLE time is too long for the time-out of TCP connection, then TCP re-transmits many TCP segments or disconnects the TCP connection.

Referring now to FIG. 6A-6B, a power level/timing diagram illustrating an example of conventional power save mode TCP communication scenarios will be discussed and described. At first, the DSC waits for an IFS (inter frame space) and then transmits a TCP segment 601. The printer transmits a MAC ACK 603 frame back to the DSC after receiving the TCP segment 601. As soon as the DSC receives the MAC ACK 603 frame, the DSC stays in a receive state during the “IDLE TIME” 635. When the printer is ready, the printer transmits a TCP ACK 605 frame. And then the DSC transmits a MAC ACK 607 frame back to the printer. This will be repeated until the DSC finishes transmitting one file (“ONE FILE TX#n”, where n is 1 through M) 619, 621, 623, 625. The printer then will print the one file 627, 629, 631, 633.

Referring now to FIG. 7, a frame structure illustrating a relationship from “User data” level to IEEE892.11 g MAC/PHY frame level will be discussed and described. Layered processing used within a packet network such as the WLAN is understood to include various layers that can vary depending on the implementation. Generally, there is provided a PLCP (physical layer convergence protocol) Layer 1, a MAC (media access control) sublayer of Layer 2, an LLC (logical link control) sublayer of Layer 2, an IP (Internet protocol) Layer 3, a TCP (transmission control protocol) Layer 4, and an application layer APPS. The functionality of these layers is generally understood.

The application layer is the layer closest to the end user and/or software application. Some examples of conventional application layer implementations include Hypertext Transfer Protocol (HTTP), File Transfer Protocol (FTP), and Simple Mail Transfer Protocol (SMTP). The application layer provides user data 701 to be transmitted.

At the TCP Layer 4, the user data 701 is incorporated into the TCP payload 705, and a TCP header 703 is prefixed. Together the TCP payload and the TCP header form a TCP packet which is provided in known TCP packet format.

At the IP Layer 3, the TCP packet is incorporated into an IP payload 709, and a IP header 707 is prefixed. Together the IP payload 709 and the IP header 707 form the IP packet which is provided in known IP packet format.

At the LLC sublayer of Layer 2, the IP packet is incorporated into the LLC payload 713, and a LLC header 711 is prefixed. Together the LLC payload 713 and the LLC header 711 form the LLC packet which is provided in known LLC packet format.

At the MAC sublayer of Layer 2, the LLC packet is incorporated into the MAC-SDU 717, a MAC header 715 is prefixed, and a MAC trailer 719 is appended. Together the MAC header 715, MAC-SDU 717 and MAC trailer 719 form the MAC packet which is provided in known MAC packet format.

At the PLCP layer 1, the MAC packet is incorporated into the PSDU 725, a tail 727 and pad 729 are appended, a PLCP preamble 721, and PLCP header 723 with signal 731 and service 733 are prefixed in accordance with known techniques which are provided as a frame. The illustrated frame is formatted, as an example, as a IEEE802.11 g ERP-OFDM PLCP frame (PPDU). According to known techniques, the frame includes 12 OFDM symbols encompassing the PLCP preamble 721, 1 OFDM symbol corresponding to the PLCP header signal 731, and a variable number of OFDM symbols corresponding to the service 733, PSDU 725, tail 727, and pad 729.

Referring now to FIG. 8, a frame structure of MAC ACK/PHY frames will be discussed and described. A MAC packet includes a MAC header 801, a MAC-SDU 803, and a MAC trailer 805. The MAC packet is incorporated into the PSDU 815; a tail 817 and pad 819 are appended; and a PLCP preamble 811, and PLCP header 813 with signal 821 and service 823 are prefixed in accordance with known techniques which are provided as a frame. The illustrated frame is formatted, as an example, as a IEEE802.11 g ERP-OFDM PLCP frame (PPDU). The PLCP preamble 811 of the frame includes 12 OFDM symbols; the PLCP header 813 includes 1 OFDM symbol 821 corresponding to the PLCP header signal 821; and a variable number of OFDM symbols corresponding to the PLCP header service 823, PSDU 815, tail 817, and pad 819.

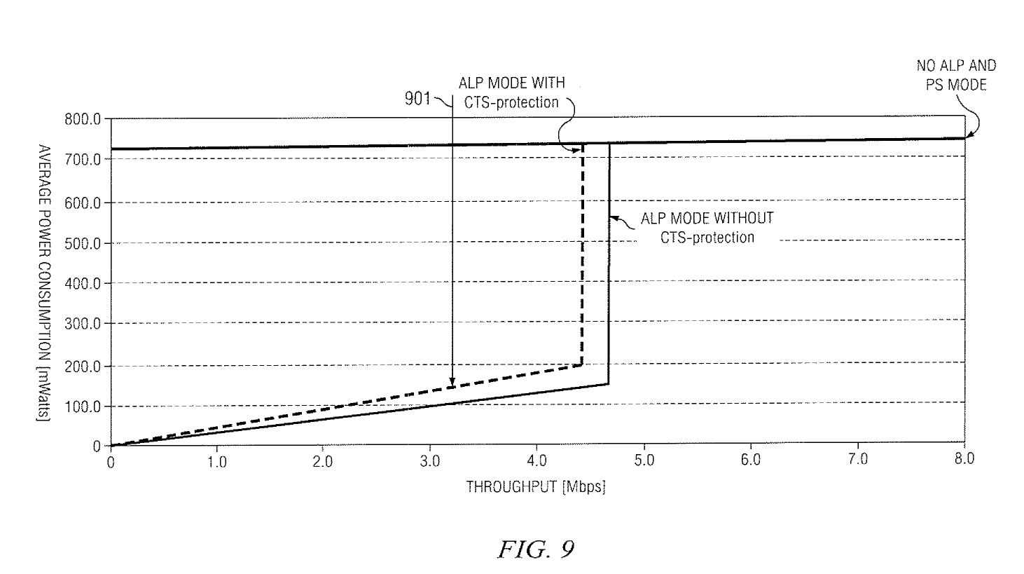

Referring now to FIG. 9, test results will be discussed and described. FIG. 9 illustrates an average power consumption (mWatts) to throughput (Mbps), for a device with ALP (advanced low power) mode without CTS-protection (e.g., FIG. 4A-4B), a device with ALP mode with CTS protection (e.g., FIG. 5A-5B), and a conventional device with no ALP or PS mode (e.g., FIG. 6A-6B).

In FIG. 9, the effectiveness of an embodiment is expressed. The result of throughput of the conventional digital still camera that the inventors actually measured, was around 3 Mbps to 4 Mbps. However, by applying this advanced low power control (ALP) mode up to about 5 Mbps, power consumption can be theoretically actualized to less than about 200 mW. If ALP mode with CTS-protection is used additionally, more reduction of power consumption can be achieved as well. The embodiment should be effective for products for which a long battery life is desired, such as a digital still camera.

FIG. 10 and FIG. 11 illustrate procedure for communicating in a WLAN at the frame level (FIG. 10) and at the TCP segment level (FIG. 11) to lower a power consumption. The procedures can advantageously be implemented on, for example, a processor of a wireless networking device, described in connection with FIG. 1 or other apparatus appropriately arranged.

Referring now to FIG. 10, a flow chart illustrating a procedure to communicate in a WLAN at WLAN frame level will be discussed and described. Many of the details have been previously described, and accordingly such details may be omitted from the following description. In general, the procedure 1001 to communicate in the WLAN at the WLAN frame level includes getting 1003 a next file to transfer to a receiving networking device, measuring the idle time to be used as the predetermined time period for a doze state of a low power level 1005, transmitting the WLAN frame (as discussed further) 1007, 1009, 1011, checking 1013 whether there is another WLAN frame in this file, and if so looping to get 1015 the next WLAN frame and repeating the transmitting of the WLAN frame 1007, 1009, 1011. If there is no next WLAN flame 1013, the procedure 1001 can loop to get 1003 the next file to transfer to a receiving networking device and repeat.

Transmitting the WLAN frame 1007, 1009, 1011 is discussed in more detail. This includes transmitting 1007 a single WLAN frame of a file transfer to a receiving networking device, and the transitioning from a transmit power level down to a state of a receive power level while waiting for an “ACK” signal to the transmitted WLAN frame.

When the ACK signal is received 1009 from the receiving networking device, the “ACK” signal triggers going into a doze state of a low power level for a predetermined time period.

The predetermined time period expires 1011, which triggers a transition to a state of a receive power level, for example for an inter-frame space while waiting to transmit a next WLAN frame.

Referring now to FIG. 11, a flow chart illustrating a procedure to communicate in a WLAN at TCP segment level will be discussed and described. Many of the details have been previously described, and accordingly such details may be omitted from the following description. In general, the procedure 1101 includes getting 1103 the next file to transfer to a receiving networking device, measuring 1105 the idle time to be used as the predetermined time period for a doze state of a low power level (discussed further), transmitting the TCP segment (as discussed further) 1107, 1109, 1111, 1113, 1115, 1117, checking 1119 whether there is another TCP segment in this file, and if so, looping to get 1121 the next TCP segment and repeating the transmitting of the TCP segment 1107, 1109, 1111, 1113, 1115, 1117. If there is no next TCP segment 1119, the procedure 1101 can loop to get 1103 the next file to transfer to a receiving networking device and repeat.

The measuring 1105 of the idle time can include measuring the idle time from a last transmitted data of a frame until a TCP “ACK” response thereto is received, which is used as the predetermined time period for a doze state of a low power level. The idle time can be repeatedly learned and adjusted (such as by averaging, trending, or the like). Also, the idle time is intended to measure the idle time of the receiving networking device.

Transmitting the TCP segment 1107, 1109, 1111, 1113, 1115, 1117 is discussed in more detail. The transmitting of the TCP segment includes transmitting 1107 a CTS-to-self frame to prevent other WLAN devices from transmitting frames.

Also, transmitting the TCP segment can include transmitting 1109 a single TCP segment of a file transfer to a receiving networking device and immediately thereafter transitioning from a transmit power level down to a state of receiving power level, while waiting for a MAC “ACK” response to the transmitting.

Furthermore, transmitting the TCP segment can include receiving 1111 the MAC “ACK” response from the receiving networking device. The MAC “ACK response can trigger going into a doze state of a low power level for a predetermined time period.

Transmitting the TCP segment also can include transmitting 1113 a CTS-to-receive-networking-device frame. This can elicit the next frame from the receiving networking device, which is expected to be a TCP “ACK”

Also, transmitting the TCP segment can include the expiration 1115 of the predetermined time period, which triggers a transition to a state of a receive power level in order to receive the expected TCP “ACK” response to the TCP segment.

Moreover, transmitting the TCP segment can include transmitting 1117 a MAC “ACK” response to the receiving networking device in response to receiving the TCP “ACK” response. This indicates that the TCP segment was completely and correctly transmitted to the receiving device.

As discussed above, the process can continue to loop for more TCP segments and additional files.

In order to compare to conventional power save mode, consider the entry into power save mode between WLAN frames during transmission of one jpeg file. The conventional power save mode enters a power save mode during an idle time like printing as shown in FIG. 3A-3B.

TCP data communication is shown in FIG. 4A-4B. Also, TCP data communication with CTS-protection mechanism is shown in FIG. 5A-5B. FIG. 6A-6B shows the conventional power save mode on TCP data communication.

Average power consumption of both the example embodiments above and the conventional power save mode is calculated below in order to clarify the effectiveness.

At first, some values related to the calculation of the average power consumption are shown below.

The transmission time of a 54 Mbps ERP-OFDM frame with MAC-SDU at 1508 [bytes], T_{TPD} as shown in Table 1 and on FIG. 7 is calculated with the following equation.

$$\begin{matrix}{T}_{TPD} = {T}_{PREAMBLE} + {T}_{SIGNAL} + {T}_{SYM} \times {N}_{SYM} \\ = 16 [ usec ] + 4 [ usec ] + 4 [ usec ] \times 58 \\ = 252 [ usec ] .\end{matrix} \qquad ( 1 )$$

Table 1, The length/time of each frame of FIG. 2A-2B:

| Field name | Length/Time | Description |
|---|---|---|
| User data/TCP payload | 1460 octets | |
| TCP header | 20 octets | |
| IP payload | 1480 octets | |
| IP header | 20 octets | |
| LLC payload/IP datagram | 1500 octets | |
| LLC header | 8 octets | |
| MAC-SDU | 1508 octets | |
| MAC header | 28 octets | ✓ “To DS”/”From DS”: 0/0. |
| | | ✓ “Address 4” is omitted. |
| | | ✓ 4 octets IV is included. |
| MAC trailer | 8 octets | 4 octets ICV is included. |
| PSDU | 1544 octets | |
| SERVICE | 2 octets | |
| TAIL | 6 bits | |
| PAD | 154 bits | ✓ @ 54 Mbps OFDM. |
| | | Note: Please see “Note1”. |
| PLCP HEADER SIGNAL | 4 usec | |
| PLCP PREAMBLE | 16 usec | |
| N_{DBPS} | 216 bits | @ 54 Mbps OFDM. |
| N_{SYM} | 58 | The number of OFDM |
| | | symbols. |
| T_{SYM} | 4 usec | |

Note 1:
The bit length, N_{PAD} of “PAD” of PPDU can be calculated as
shown below:

| | |
|---|---|
| ${N}_{SYM} = Ceiling [ \frac{16 + 8 \times [ PSDU Length ] + 6}{{N}_{DBPS}} ]$ | (2) |
| N_{DATA} = N_{SYM} × N_{DBPS} | (3) |
| N_{PAD} = N_{DATA} − (16 + 8 × (PSDU Length) + 6) | (4) |

The function Ceiling(x) is a function that returns the smallest integer value greater than or equal to its argument value, x.

Also, the transmission time of a MAC ACK frame at 24 Mbps ERP-OFDM, T_{TPA} is calculated with the following equation.

$$\begin{matrix}{T}_{TPA} = {T}_{PREAMBLE} + {T}_{SIGNAL} + {T}_{SYM} \times {N}_{SYM} \\ = 16 [ usec ] + 4 [ usec ] + 4 [ usec ] \times 2 \\ = 28 [ usec ] .\end{matrix} \qquad ( 5 )$$

One of skill in the art is assumed to be familiar with 802.11 standards, for example, “The IEEE802.11 Handbook: A Designer's Companion”, Bob O'Hara, Al Petrick, IEEE Standards Association; and ISO/IEC8802-11, ANSI/IEEE Std 802.11: Information Technology Telecommunications and information exchange between systems-Local and metropolitan area networks-Specific requirements—Part 11—Wireless LAN medium Access Control (MAC) and Physical Layer (PHY) specifications, (1999) (both expressly incorporated herein by reference).

It should be noted that the term wireless networking device may be used interchangeably herein with wireless device, wireless networking unit, or the like. Each of these terms denotes typically a wireless mobile device that may be used with a wireless local area network. Examples of such units include digital still cameras (DSC), printers, personal digital assistants, personal assignment pads, personal computers, home display, and digital photo printers, provided such devices are arranged and constructed for communication with other devices in a WLAN.

The processor can be equipped to be running in different power management modes: the designations “doze state” or “doze state of low power” are used herein to mean the definition of the IEEE 802.11x standards, e.g., “11.2.1.1 STA Power Management modes,” IEEE 802.11 (1999) standard and variations and evolutions thereof, in which the device is not able to transmit or receive; the designation “transmit power level” is used herein to mean a power management mode in which the power level of the device is sufficient to transmit and receive; the designation “receive power level” is used herein to mean a power management mode in which the power level of the device is sufficient to receive but not transmit. One of skill in the art appreciates that “doze state” and “doze state of low power” do not mean that the processor is powered off (and in some instances may be using power sufficient only to maintain memory). The doze state of low power uses less power than the receive power level, and the receive power level uses less power than the transmit power level. An appropriate processor is a microprocessor with power management modes corresponding to the above, for example, the MSP430 microcontroller, for example, the MSP430C1351, available from Texas Instruments, and variations and evolutions thereof.

Furthermore, the communication networks of interest include those that transmit information in packets, for example, those known as packet switching networks that transmit data in the form of packets, where messages can be divided into packets before transmission and further divided into TCP segments and frames and the transmitted to a destination where the packets are reassembled into the message. Such networks include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, UDP/UP (Universal Datagram Protocol/Universal Protocol), IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A wireless networking device, comprising:
a transceiver operable to transmit and receive communications over at least a portion of a wireless local area network (WLAN); and
a processor cooperatively operable with the transceiver, and configured to facilitate:
transmitting over the transceiver one WLAN frame of a file transfer to a receiving networking device and then transitioning from transmit power level down to a state of receive power level while waiting for an “ACK” signal to the transmitting;
receiving over the transceiver the “ACK” signal from the receiving networking device, and the “ACK” signal triggers going into a doze state of a low power level for a predetermined period of time; and
the predetermined period of time expires and triggers transitioning to a state of receive power level for an inter-frame space while waiting to transmit a next WLAN frame,
the low power receive power level being lower than the receive power level.

2. The device of claim 1, further comprising a timer operably connected to the processor, the predetermined period of time being counted in the timer during the doze state.

3. The device of claim 1, the processor being configured to measure an idle time from a last transmitted data of a frame until an “ACK” signal in response thereto is received and to select the predetermined period of time for the doze state to be less than the measured idle time.

4. The device of claim 3, the processor being further configured to learn the measured idle time and set the measured idle time into a WLAN circuit controlling the transmitting of the one WLAN frame.

5. The device of claim 1, the processor being configured to transfer the file which is transferred as a print file with plural WLAN frames including the one WLAN frame, with corresponding doze states between the plural WLAN frames.

6. The device of claim 1, the wireless networking device being a digital still camera, the processor being configured to transfer the file which is transferred as a picture data file with plural WLAN frames including the one WLAN frame, with corresponding doze states between the plural WLAN frames.

7. A wireless networking device, comprising:
a transceiver operable to transmit and receive communications over at least a portion of a wireless local area network (WLAN); and
a processor cooperatively operable with the transceiver, and configured to facilitate:
transmitting over the transceiver one transmission control protocol (TCP) segment of a file transfer to a receiving networking device and then transitioning down to a state of receive power level while waiting for a MAC “ACK” response to the transmitting;
receiving over the transceiver the MAC “ACK” response from the receiving networking device, and the MAC “ACK” response triggers going into a doze state of a low power level for a predetermined period of time; and
the predetermined period of time expires and triggers transitioning to a state of receive power level while waiting to receive a TCP “ACK” response to the TCP segment, the low power receive power level being lower than the receive power level.

8. The device of claim 7, wherein the processor is configured to transmit a second MAC “ACK” response to the receiving networking device when the TCP “ACK” response to the TCP segment is received.

9. The device of claim 7, further comprising a timer operably connected to the processor, the predetermined period of time being counted in the timer during the doze state.

10. The device of claim 7, the processor being configured to measure an idle time from a last transmitted data of a frame until a TCP “ACK” response in response thereto is received and to select the predetermined period of time for the doze state to be less than the measured idle time.

11. The device of claim 7, the processor being further configured to learn the measured idle time and set the measured idle time into a WLAN circuit controlling the transmitting of the one TCP segment.

12. The device of claim 7, the wireless networking device being a digital still camera, the processor being configured to transfer the file which is transferred as a picture data file with plural TCP segments including the one TCP segment, with corresponding doze states between the plural TCP segments.

13. The device of claim 7, wherein the processor is configured to transmit a CTS-to-self frame before transmitting the TCP segment, to prohibit other WLAN devices in the WLAN network from transmitting a WLAN frame to the device.

14. The device of claim 7, wherein the processor is configured to transmit a CTS-to-receiving-network-device frame, triggered by expiration of the CTS-to-self.

15. A method of communicating in a wireless local area network (WLAN), comprising:
at a wireless networking device, transmitting one WLAN frame of a file transfer to a receiving networking device and then transitioning from a transmit power level down to a state of receive power level while waiting for an “ACK” signal to the transmitting;
at the wireless networking device, receiving the “ACK” signal from the receiving networking device, and the “ACK” signal triggers going into a doze state of a low power level for a predetermined period of time; and
at the wireless networking device, the predetermined period of time expires and triggers transitioning to a state of receive power level for an inter-frame space while waiting to transmit a next WLAN frame,
the low power receive power level being lower than the receive power level.

16. The method of claim 15, the predetermined period of time being counted during the doze state in a timer within the wireless networking device.

17. The method of claim 15, the predetermined period of time for the doze state being selected to be less than an idle time measured from a last transmitted data of a frame until an “ACK” signal in response thereto is received.

18. The method of claim 17, further comprising learning the measured idle time and setting the measured idle time into a WLAN circuit in the wireless networking device.

19. The method of claim 15, the file which is transferred being a print file with plural WLAN frames including the one WLAN frame, with corresponding doze states between the plural WLAN frames.

20. The method of claim 15, the wireless networking device being a digital still camera, the file which is transferred being a picture data file with plural WLAN frames including the one WLAN frame, with corresponding doze states between the plural WLAN frames.
